(19) United States
(12) Patent Application Publication
(10) Pub. No.: US 2016/0301828 A1
(43) Pub. Date: Oct. 13, 2016

(54) VISUAL AXIS OPTIMIZATION FOR ENHANCED READABILITY AND COMPREHENSION

(71) Applicant: Sarfaraz K. Niazi, Deerfield, IL (US)

(72) Inventor: Sarfaraz K. Niazi, Deerfield, IL (US)

(21) Appl. No.: 15/188,636

(22) Filed: Jun. 21, 2016

Related U.S. Application Data
(63) Continuation-in-part of application No. 14/308,462, filed on Jun. 18, 2014.

(51) Int. Cl. H04N 1/387; G06K 15/02

(52) U.S. Cl. CPC H04N 1/3877; G06K 15/02

(57) ABSTRACT

The printed text is vertically aligned at 90 degrees, the visual axis of the reader does not align properly when the head is moved to read the left or the right page resulting in difficulties in readability and comprehension. These difficulties are resolved by printing the text at an angle.

### CROSS REFERENCE TO RELATED APPLICATION

This application is a continuation-in-part of U.S. Patent Application Serial No. 14/308,462, entitled “Visual Axis Optimization for Enhanced Readability and Comprehension” filed on Jun. 18, 2014, the contents of which are incorporated herein by reference in its entirety.

### BACKGROUND OF THE INVENTION

The ability to read and write is our greatest tool in education and transmission of ideas and the continuance of an evolving human culture. Readability and comprehension of printed text and figures is pivotal for education and communication. Historically, the text and images on a printed page are horizontally aligned over the past thousands of years without realizing that as we turn our face towards a right page or the left page, the axis of our eyes misaligns with the axis of the printed text or image stress in our brain. For most people with normal brain function, the misalignment is overcome by repeated practice but it may not be the case for those inflicted with dyslexia or attention deficit hyperactivity disorder.

While most of the differences in the aptitude and the attitude of the people in reading are attributed to their training and intellect, one cause that has never been recognized is the stress produced by reading a text misaligned to the axis of the eye to cause aversion to reading.

There is no prior art to reduce the misalignment of the axis of the eye and the axis of a printed page to reduce stress on the brain; the instant invention resolves this inadequacy of the art by printing pages at an angle.

### BRIEF SUMMARY OF THE INVENTION

Modern book printing follows the style developed a long time ago, a book bound at the spine with left and right pages. However, as we open the book, holding in front of our face, we are inevitably forced to turn our head to left or to right to read what is on the left of the right page, unless we are holding it and reading it as a single page placed aligned with the axis or our eyes. FIG. 1 shows the alignment of the eye axis with text on the left and right pages showing that the horizontal axis of the eye aligns only in the middle of the spine of the book. FIG. 2 shows the misalignment of the printed text and the axis of our eyes regardless of whether we are reading the left page of the right page. Whereas we may have become used to such reading style over years, this is not a natural scanning format of our eyes that are more capable of aligning objects vertically or horizontally.

While normal children and adults may become used to reading a text misaligned with the axis of their eyes, such may not be the case with those suffering from dyslexia or attention deficit disorder.

Dyslexia is a learning disability that manifests itself as a difficulty with word decoding and/or reading fluency. Comprehension may be affected as a result of difficulties with decoding, but is not a primary feature of dyslexia. It is separate and distinct from reading difficulties resulting from other causes, such as a non-neurological deficiency with vision or hearing, or from poor or inadequate reading instruction. It is estimated that dyslexia affects between 5-17% of the population. Dyslexia has been proposed to have three cognitive subtypes (auditory, visual and attentional), although individual cases of dyslexia are better explained by the underlying neuropsychological deficits and co-occurring learning disabilities (e.g. attention-deficit/hyperactivity disorder, math disability, etc.). Although not an intellectual disability, it is considered both a learning disability and a reading disability. Nerve problems can cause damage to the control of eye muscles which can also cause diplopia.

Attention-deficit/hyperactivity disorder (ADHD) is a brain disorder marked by an ongoing pattern of inattention and/or hyperactivity-impulsivity that interferes with functioning or development.

The prior art is silent on any suggestions to reduce this misalignment of the axis of the eye and the axis of the printed matter. There is, therefore, need to invent a method to reduce this misalignment to improve the readability of text and through that comprehension of the printed matter, especially for those suffering from dyslexia or attention deficit hyperactivity disorder.

### BRIEF DESCRIPTION OF THE OF THE DRAWINGS

FIG. 1 depicts the misalignment of the eye axis with the traditionally printed text on the left and right pages.

FIG. 2 depicts the alignment of the eye axis with rotated printed text on the left and right pages.

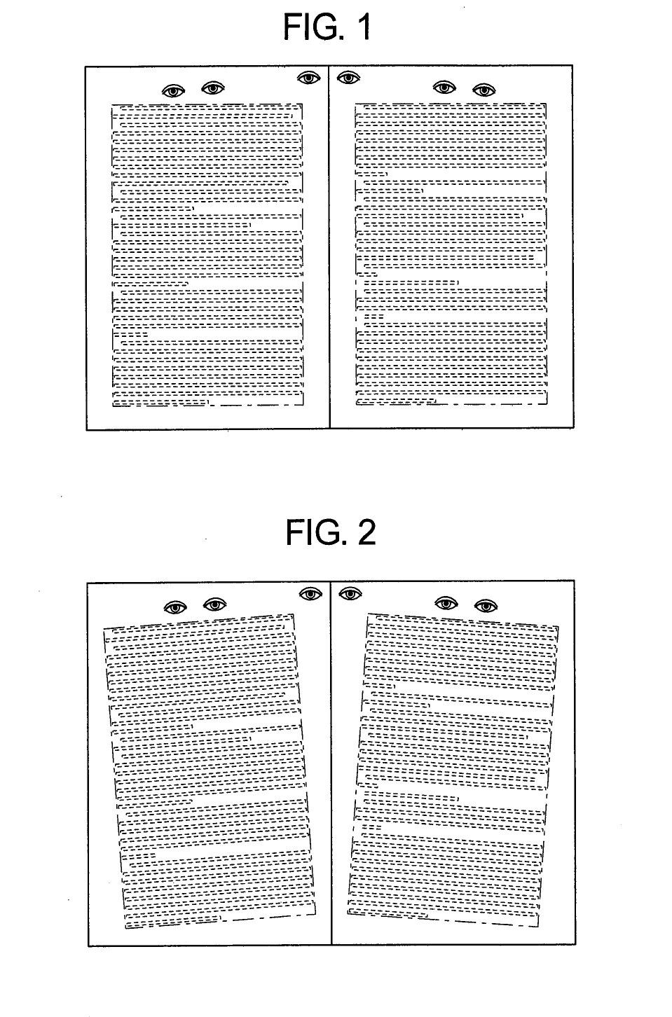

### DETAILED DESCRIPTION OF THE INVENTION

Generally, books have left and right pages, which are invariably printed straight on a vertical axis. The human eyes have a horizontal axis, and when the face is rotated towards the left or the right page, the horizontal axis of the eyes is no longer aligned with the vertical axis creating a situation where the eyes scan the text not in alignment with eyes. While most of us have been trained to read this misaligned text, this exercise inevitably creates stress on the visual apparatus. Removing this stress is likely to improve the readability of the text, the speed of reading and above all, comprehension of the text—all of which will add to the productivity and efficiency of the reader. One aspect of the stress in reading can result in an aversion to reading, a phenomenon widely observed at all ages. Removing the stress in reading can reduce the aversion and thus increase literacy and wider use of books. More particularly, this may help children starting to read when they have not yet accustomed to accommodating this stress in reading. And above all, this would greatly assist dyslexia and attention deficit hyperactivity disorder subject.

The stress in reading from accommodating to align the text with the axis of the eye may also result in various physiological phenomena such as headaches, and other outcomes that may have kept many from being fluent in reading books.

The extent of misalignment of the horizontal axis of the eye and the vertical axis of the text in a book depends on how far is the book held from the eyes. At a greater distance, this misalignment may be minimal but the recommended distance of about nine inches to 24 inches, this is significant. The closer is the book held to the eyes; the greater is the misalignment. Contrary to the popular belief, reading a book keeping it closer to the eye of reading in the dim light does not affect the eyes, in fact, it strengthens the muscles of the eye that control the eyes lens; this old wives' tale has been deeply embedded in our culture.

Reading a misaligned text is deeply embedded in our training. There is no prior art that suggests that this misalignment is of any importance; we have accepted the book design to be fundamental and published billions of books using this format. There is, therefore, need to correct this historic misunderstanding in our physiologic responses to reading the text.

It is obvious that the alignment of the axis of the eye and the axis of the printed text will continually change as one reads the book; therefore, the goal of the invention is not to create a perfect alignment, as such is not necessary. The stress will be proportional to misalignment and any change in the degree to which the text is rotated will reduce the stress; in most instances, a change of 1-10 degrees will be sufficient to be noticed by the reader.

How far can the text be rotated is limited by the dimension of the book; since the dimension of the field is fixed, rotation of text beyond a certain limit will make it impossible for the text to be printed in the lower part of the page. One way to increase the visibility while increasing the tilt is to reduce the font size allowing more text to be printed; ideally, the alignment will be limited to complete lines of text when the text is rotated to the left or the right axis. As a result, the extent of alignment will depend on the margins allowed on the page. This is further limited by the minimum margins required for the printing of the text. If for example, the printing bleed required is about a quarter of inches and the text is formatted for one-inch margins, there is only a ¾-inch adjustment that is available to change the rotation of the text. To keep the readability, this may well be the limiting condition of the text margin in the printed text.

In a preferred embodiment of the invention, the text is printed on the left page at an angle less than 90 degrees and the text on the right page is printed at more than 90 degrees in the extremes.

In a second embodiment, the text on the right and the left pages is rotated to a degree ranging from 0.5 to 90 degrees. The angle of text on the left page is ideal between 45 and 89 degrees and between 91 and 134 degrees on the right page.

While the printers are generally designed to print text or pictures aligned with the horizontal and vertical margins of a paper, printing text of pictures is a simple task and can be accomplished in any word processing software such as Microsoft Word by creating a text box, typing the text in the box and rotating the text box. This may also be accomplished by converting a text into a picture and rotating the picture placed in the document to the desired angle. Other approaches include software to manipulate printers as described in the US Patent Application 2011/0286034 of Hirano. However, neither Hirano nor the word processing instruction discloses the use of angled printing to reduce the misalignment of the axis of the eye to the axis of the printed page.

What is claimed is:

1. A method for improving readability and comprehension of text and images by those in need of improving readability and comprehension of text and images comprising printing the text and images at an angle to reduce misalignment of a horizontal axis of the eyes and a horizontal axis of a printed text and image.

2. The method of claim 1, wherein those in need of improving readability and comprehension of text and the images comprise dyslexia or attention deficit hyperactivity disorder patients.

3. The method of claim 1, wherein the text and images are printed at an angle of less than 90 degrees on a left page and at an angle of greater than 90 degrees on a right page of a set of bound or unbound pages.

4. The method of claim 1, wherein the text and images are printed at an angle of 45 to 89 degrees on the left page and 91 to 135 degrees on the right page.

5. The method of claim 1, wherein the text and images are printed on a material surface.

6. The method of claim 5, wherein the text and images are part of a book, magazine, or a brochure.

7. The method of claim 5, wherein the text and images appear on paper, plastic, wood, metal or rubber surface.

8. The method of claim 5, wherein the material surface is flexible.
